(19) United States
(12) Patent Application Publication
(10) Pub. No.: US 2002/0160156 A1
(43) Pub. Date: Oct. 31, 2002

(54) Extensible packaging element and stretchable packaging element

(76) Inventor: Chun-Tse Yang, Kaohsiung (TW)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/845,017

(22) Filed: Apr. 27, 2001

(51) Int. Cl. B32B 3/28

(52) U.S. Cl. 428/182

(57) ABSTRACT

An extensible packaging element is disclosed for positioning and cushioning an article. The extensible packaging element comprises two fasteners and a stretchable portion. The two fasteners are mounted on two ends of the packaging element so that the extensible packaging element can link with another extensible packaging element to extend the size of the extensible packaging element. Therefore, the connected extensible packaging element can suit articles of various sizes and weights. According to the invention, the cost of the molds can be decreased and the manufacturing efficiency can be improved. A stretchable packaging element is also disclosed for positioning and cushioning an article. The stretchable packaging element comprises two non-stretchable portions and a stretchable portion. The stretchable packaging element is manufactured in one size for saving the space and reducing the cost. They are used to package up articles of various sizes.

### BACKGROUND OF THE INVENTION

1. Field of the Invention

The present invention relates to a packaging element, more particularly, to an extensible packaging element and a stretchable packaging element.

2. Description of the Related Art

Conventional packaging elements are manufactured by fixed molds. To package up articles of large size or different sizes, the packaging elements of different sizes will be required. In manufacture, the packaging elements of different sizes will need more space and cost more for mass-production Therefore, it is necessary to provide a packaging element for packaging up articles of various sizes and having high manufacture efficiency.

Conventional packaging elements are designed according to the size and weight of the articles and manufactured by fixed molds. They only can package the articles of fixed size and weight. Molds of different sizes are needed and their costs are high. Therefore, it is necessary to provide packaging elements that can link together and stretch to package up articles of various sizes so that the cost can be decreased and the packaging efficiency can be improved.

### SUMMARY OF THE INVENTION

One objective of the present invention is to provide a stretchable packaging element. They are manufactured in one size in order to save the space and lower the cost. They can be used to package up articles of different sizes.

One objective of the present invention is to provide extensible packaging elements. They have two fasteners mounted on their two ends so that they can link with other extensible packaging elements to extend the size of the packaging elements. Therefore, the connected extensible packaging elements can package up articles of various sizes and weights of various articles. According to the inventions the cost of the molds can be reduced and the manufacturing efficiency can be improved.

Another objective of the present invention is to provide an extensible packaging element. The extensible packaging element comprises a stretchable portion in a shape of bellows so that the extensible packaging element can stretch to suit the size of the article.

Another objective of the present invention is to provide an extensible comer packaging element for supporting a comer of the article. The extensible corner packaging element comprises at least two fasteners to link with other extensible packaging elements of the invention.

### BRIEF DESCRIPTION OF THE DRAWINGS

FIG. 1a shows a perspective view of the extensible packaging element, according to the first embodiment of the invention.

FIG. 1b shows a cross-section view of the extensible packaging element in un-stretched position, according to the first embodiment of the invention.

FIG. 1c shows a cross-section view of an extensible packaging element in stretched position, according to the first embodiment of the invention.

FIG. 2 shows a perspective view of the extensible packaging element, according to the second embodiment of the invention.

FIG. 3 shows a perspective view of the extensible packaging element, according to the third embodiment of the invention.

FIG. 4 shows a perspective view of the extensible corner packaging element, according to the fourth embodiment of the invention.

FIG. 5 shows a perspective view of the extensible comer packaging element, according to the fifth embodiment of the invention.

FIG. 6a shows a perspective view of the extensible packaging element in un-stretched position, according to the sixth embodiment of the invention.

FIG. 6b shows a perspective view of the extensible packaging element in stretched position, according to the sixth embodiment of the invention.

FIG. 7a shows a cross-section view of the extensible packaging element in un-stretched position, according to the sixth embodiment of the invention.

FIG. 7b shows a cross-section view of the extensible packaging element in stretched position, according to the sixth embodiment of the invention.

FIG. 8 shows a perspective view connecting the extensible packaging elements, according to the invention.

FIG. 9 shows a perspective view of a stretchable packaging element, according to the seventh embodiment of the invention.

FIG. 10 shows a perspective view of the stretchable packaging element in stretched position, according to the seventh embodiment of the invention.

FIG. 11 shows a plan view of the stretchable packaging element, according to the seventh embodiment of the invention.

FIG. 12 shows a plan view of the stretchable packaging element in stretched position, according to the seventh embodiment of the invention.

FIG. 13 shows a perspective view using the stretchable packaging element to package up the article, according to the seventh embodiment of the invention.

FIG. 14 shows a perspective view using the stretchable packaging element in stretched position to package up the article, according to the seventh embodiment of the invention.

FIG. 15 shows a plan view of the stretchable packaging element, according to the eighth embodiment of the invention.

FIG. 16 shows a plan view of the stretchable packaging element in stretched position, according to the eighth embodiment of the invention.

### DETAILED DESCRIPTION OF THE INVENTION

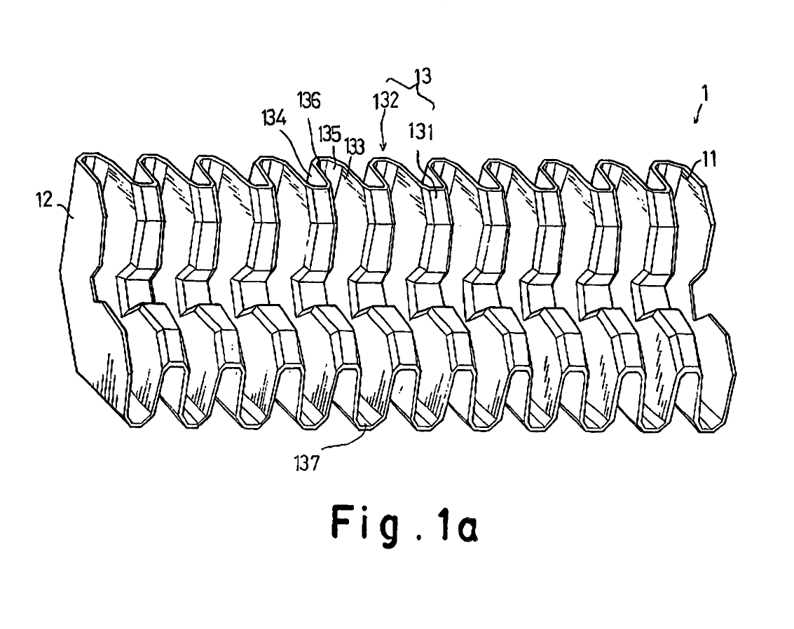

Referring to FIG. 1a, an extensible packaging element 1 comprises two fasteners 11, 12, and a stretchable portion 13. The two fasteners 11, 12 are mounted on two ends of the extensible packaging element 1. The stretchable portion 13 is mounted between the two fasteners 11, 12 and connected to the two fasteners 11, 12.

The stretchable portion 13 comprises at least one protrude 131 and at least one slope section 132. The protrude 131 and the slope section 132 are alternately connected to form the stretchable portion 13 in a shape of bellows. The protrude 131 is not stretchable and the slope section 132 is stretchable. The slope section 132 comprises two extended slope strips 133, 134, two short slope strips 135, 136, and a valley 137. The two extended slope strips 133 and 134 are connected to the protrude 131. The two short slope strips 135 and 136 are respectively connected to the extended slope strips 133 and 134. The valley 137 is connected to the short slope strips 135 and 136. The two short slope strips 135 and 136 can have a better stretch.

Referring to FIGS. 1b and 1c, because of the structure of the stretchable portion 13, the extensible packaging element 1 can stretch to suit the size of the article. Besides, the strength of the stretchable portion 13 can be increased to make the extensible packaging element to bear various weights of the articles.

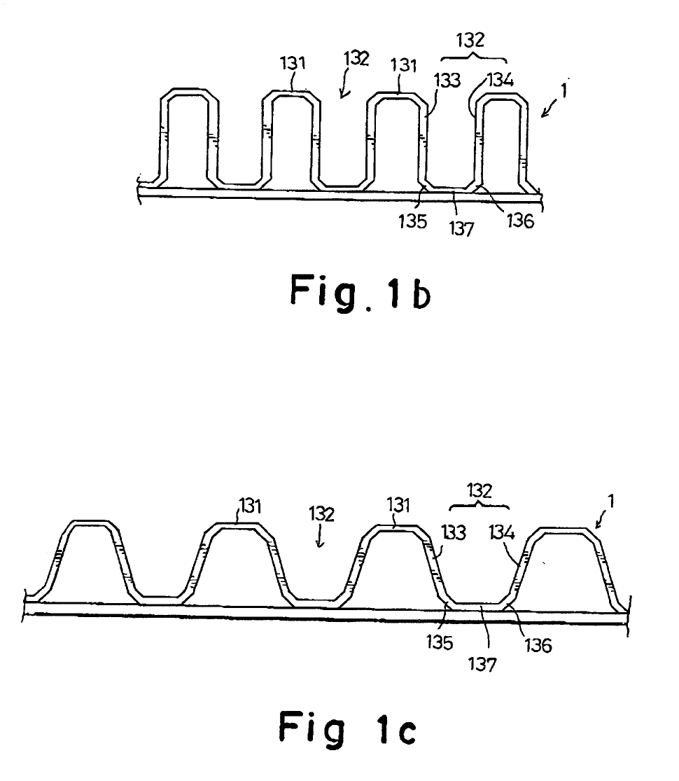

The two fasteners 11, 12 of the extensible packaging element I are 20 plates extending upwardly from the slope section 132 of the stretchable portion 13. The two fasteners 11 and 12 can link with the fasteners 21, 22 of the extensible packaging element 2 shown in FIG. 2.

FIG. 2 shows the extensible packaging element 2 according to the second embodiment of the invention. The difference between the extensible packaging element 1 and the extensible packaging element 2 is that the two fasteners 21, 22 of the extensible packaging element 2 are plates extending downwardly from the protrude 231 of the flexible portion 23. Therefore, The two fasteners 21 and 22 can fasten with the fasteners 11, 12 of the extensible packaging element 1 to extend the length of the packaging element so as to suit the size of the article.

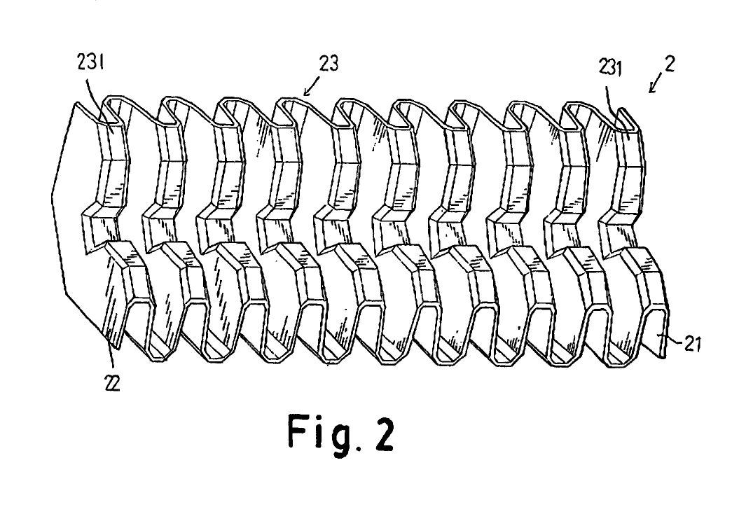

Referring to FIG. 3, the extensible packaging element 3 is similar to the extensible packaging element 1. The fastener 31 of the extensible packaging element 3 is the plate extending upwardly from the slope section 332 of the stretchable portion 33, the fastener 32 is the plate extending downwardly from the protrude 331 of the stretchable portion 353. Therefore, The fastener 31 can link with the fastener 32 of the other extensible packaging element 3 to extend the length of the packaging element.

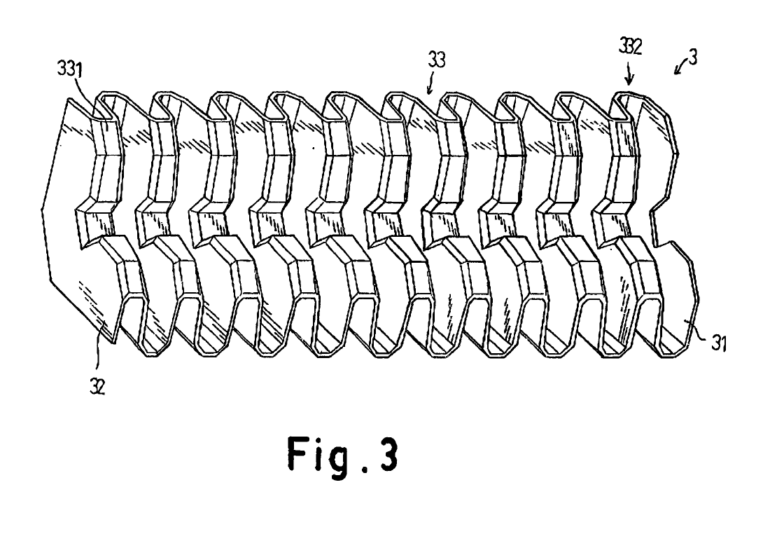

As shown in FIG. 4, the extensible corner packaging element 4 comprises two fasteners 41, 42 and a support portion 43. The support portion 43 comprises three protrudes 431, 432, 433. The protrude 432 is vertical to the protrude 433 to form a support portion 43 for supporting a corner of the article. The two fasteners 41, 42 of the extensible comer packaging element 4 are plates respectively extending downwardly from the protrudes 432, 433 to link with the fasteners 11, 12 of the extensible packaging element 1. Of course, the two fasteners 41, 42 could be the structure of the two fasteners 11, 12 or the structure of the fasteners 31, 32.

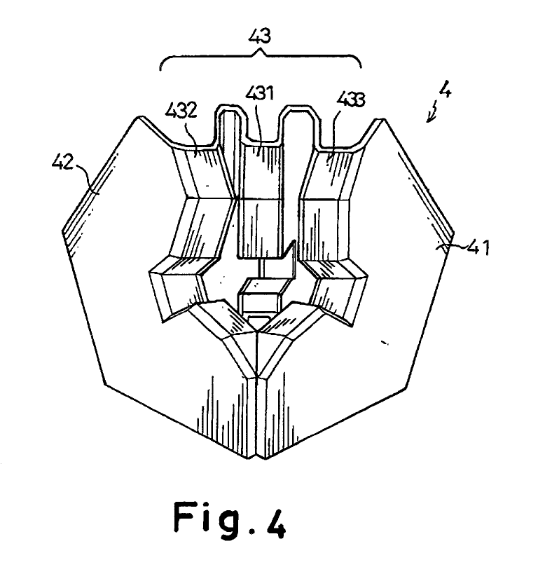

Referring to FIG. 5, the extensible corner packaging element 5 comprises three fasteners 51, 52, 53 and a support portion 54. The support portion 54 is used to support a corner of the article. The three fasteners 51, 52, 53 of the extensible corner packaging element 5 are plates extending upwardly from the support portion 54 to link with the fasteners 21, 22 of the extensible packaging element 2. After the three fasteners 51, 52, 53 link with the fasteners 21, 22 of the extensible packaging element 2, three sides at the comer of the article can be packaged.

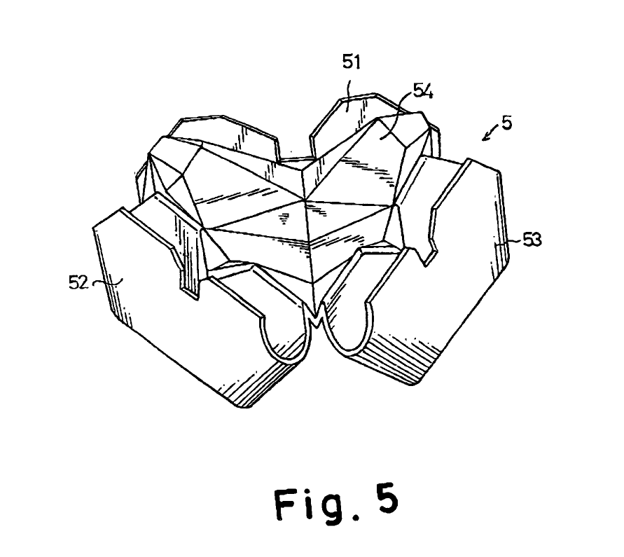

Referring to FIG. 6a, the extensible packaging element 6 comprises two fasteners 61, 62 and a stretchable portion 63. The stretchable portion 63 comprises at least one of protrudes 631, 633, 635 and at least one of slope sections 632, 634. The protrudes 631, 633, 635 and the slope sections 632, 634 are alternately connected to form the stretchable portion 63 in a shape of bellows In manufacture, if the extensible packaging element 6 is made of pulp, the section between the protrude 631 and the slope section 632 is designed to have less pulp. Referring to FIG. 6b, when the extensible packaging element 6 is stretched, the tears 636 are formed on the protrude 631 and the slope section 632. Therefore, the protrude 631 is lower than the other protrudes 633, 635 to form a low protrude.

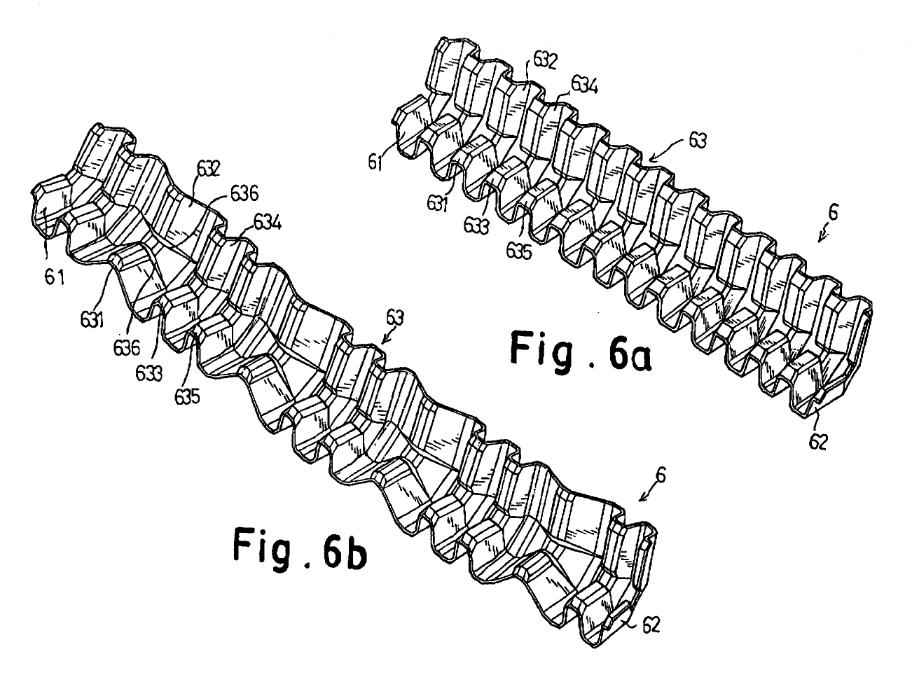

Referring to FIGS. 7a and 7b, if an article has a support pad 101, the support pad 101 can be placed above the area of the low protrude 631. Besides, the space between the article 100 and an outer packaging element 200 is fixed to maintain adequate safe distances.

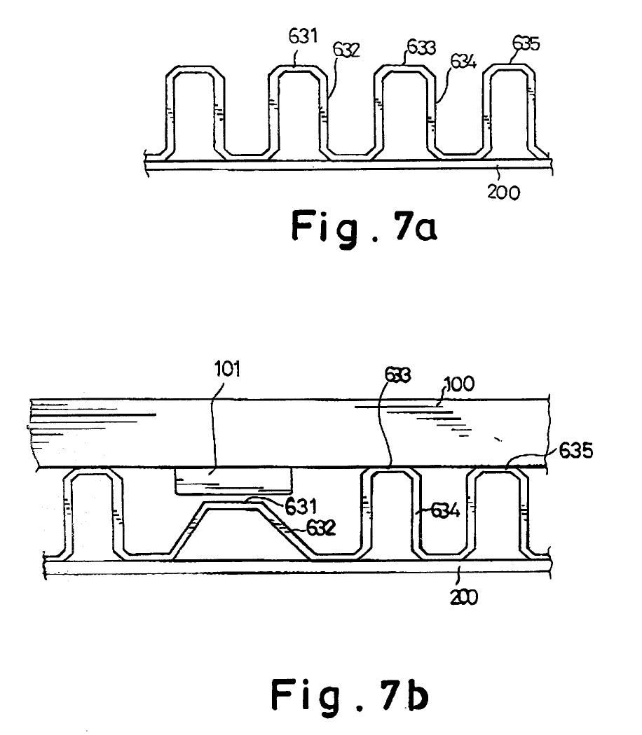

As shown in FIG. 8, according to the size and the weight of the article, four extensible packaging elements 1 and four extensible comer packaging elements 4 are connected to package up the article. Therefore, the above extensible packaging elements of the invention can be connected to package up various articles which will decrease the cost of the mold and improve the manufacturing efficiency.

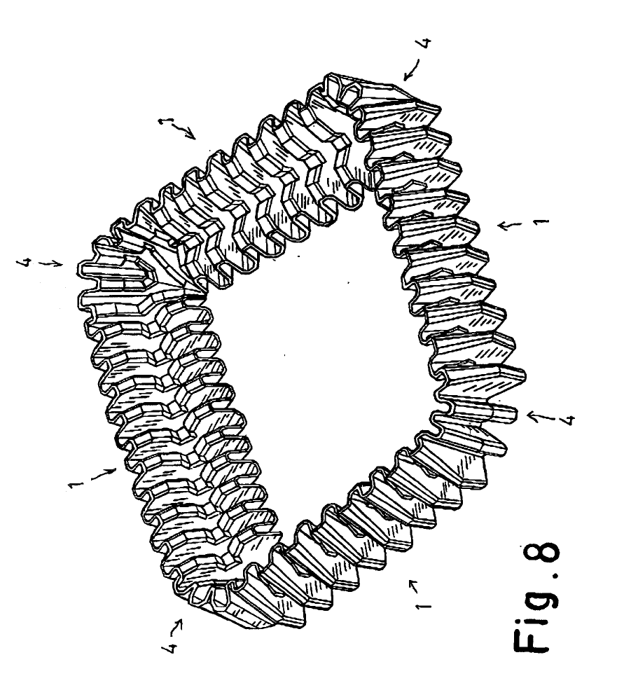

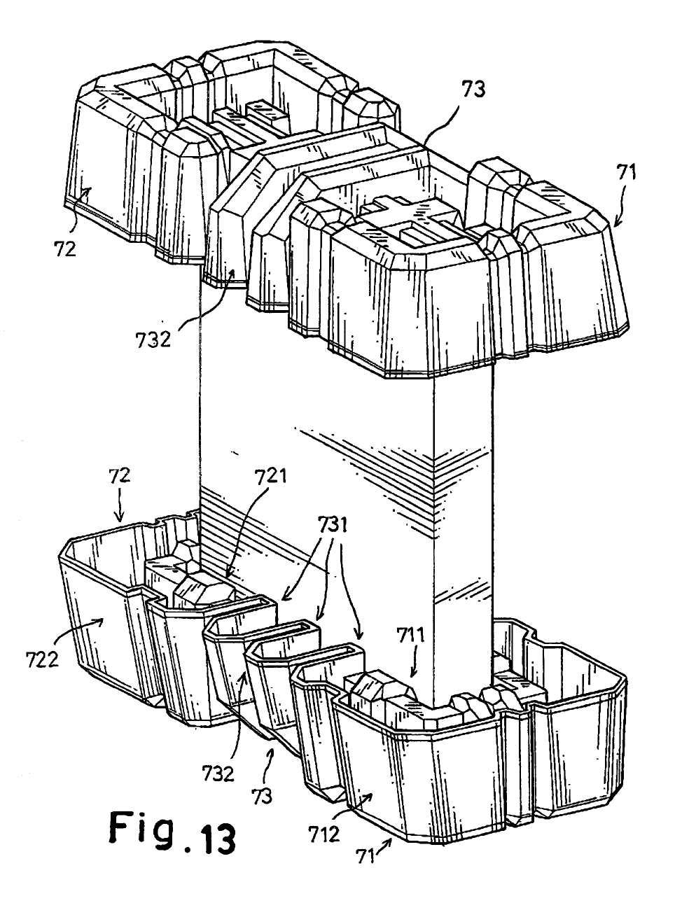

Referring to FIG. 9 and FIG. 13, a stretchable packaging element 7 comprises two non-stretchable portions 71, 72 and a stretchable portion 73. A first non-stretchable portion 71 and a second non-stretchable portion 72 are respectively mounted on two sides of the packaging element 7. The stretchable portion 73 is mounted between the two non-stretchable portions 71, 72, and connected to the first non-stretchable portion 71 and the second non-stretchable portion 72.

The first non-stretchable portion 71 and the second non-stretchable portion 72 form a corrugated surface 711 and 721 for contacting the article and for cushioning the article respectively. Besides, the first non-stretchable portion 71 and the second non-stretchable portion 72 form a corrugated surface 712 and 722, respectively on the outer circumferences to provide finer cushioning efficiency to the article. The stretchable portion 73 comprises at least one non-stretchable strip 731 and at least one stretchable strip 732. The non-stretchable strip 731 and the stretchable strip 732 are alternately connected to form the stretchable portion 73 in a shape of bellows.

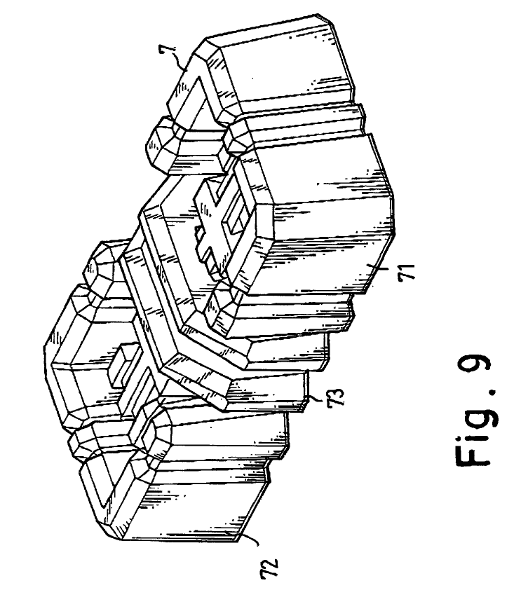

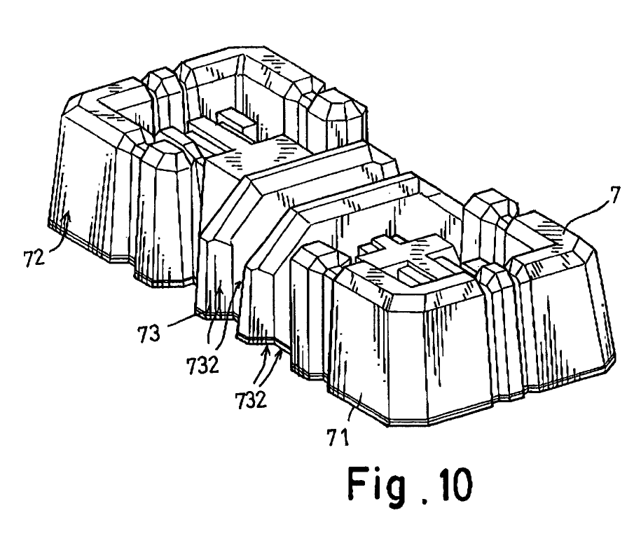

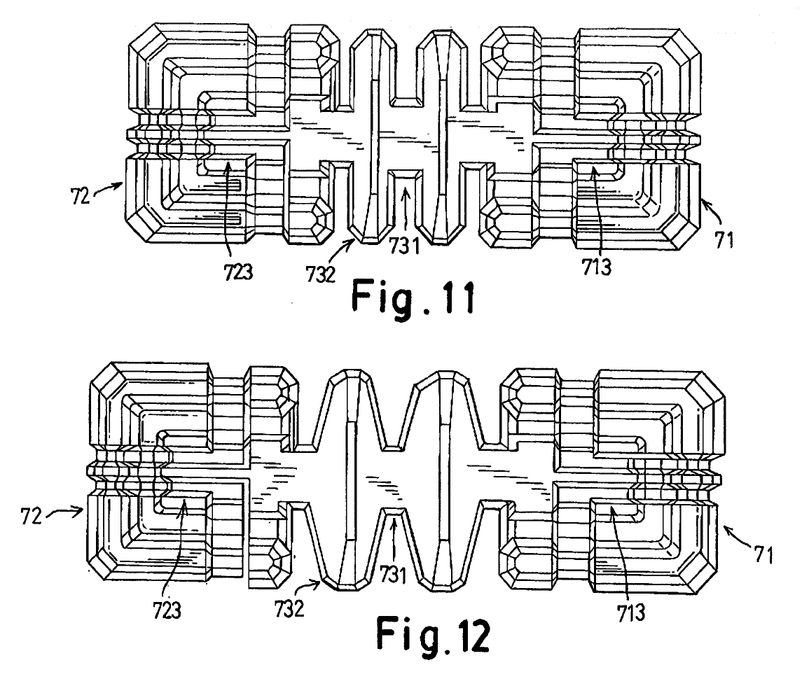

The stretchable packaging element 7 is manufactured in un-stretched position with smaller length or width. In use, the stretchable packaging element 7 is stretched as shown in FIG. 10. After the stretchable portion 73 is stretched, the length of the stretchable packaging element 7 is increased. Referring to FIG. 11 and FIG. 12, the stretchable strip 732 is stretched to increase the length of the stretchable portion 73. The first non-stretchable portion 71 and the second non-stretchable portion 72 comprise projections 713 and 723 for supporting and cushioning the article, respectively.

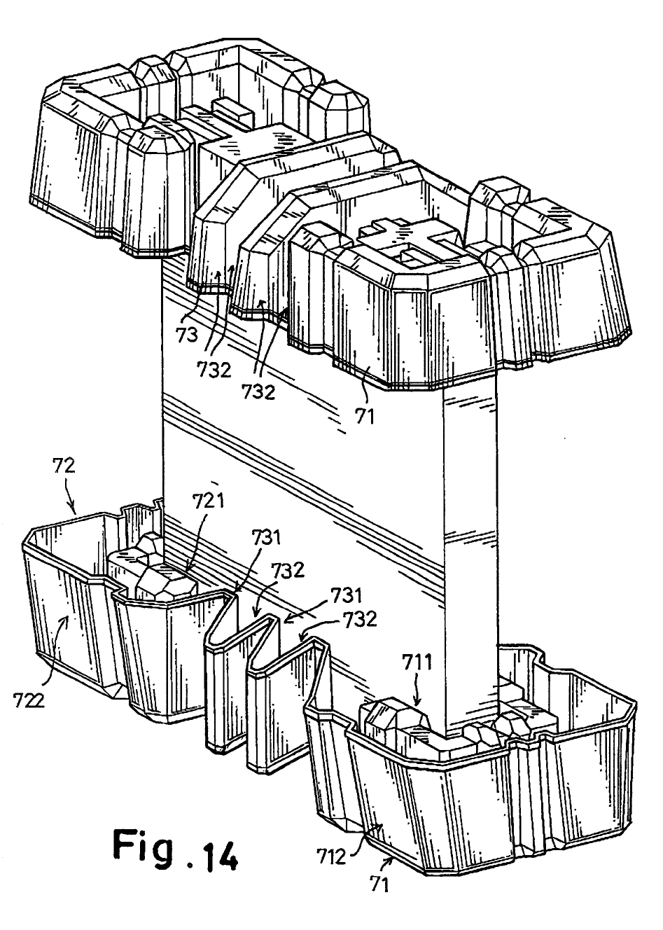

Referring to FIG. 14, the stretchable packaging element 7 is stretched to increase the length of the stretchable packaging element 7 so as to package up the larger article. The stretchable packaging element 7 can be used to package up articles of various sizes. The cost of the stretchable packaging element can be decreased, and the production quantity can be increased.

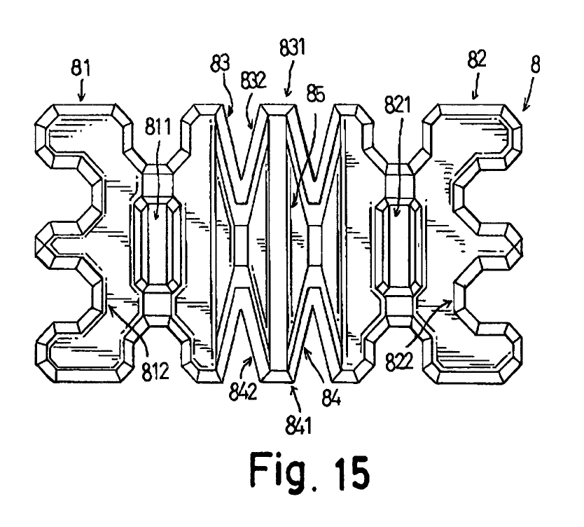

Referring to FIG. 15, the stretchable packaging element 8 comprises two non-stretchable portions 81, 82, a first stretchable section 83 and a second stretchable section 84. A first non-stretchable portion 81 and a second non-stretchable portion 82 are mounted on two sides of the packaging element 8, respectively. The first stretchable section 83 is in a corrugated shape connected to the first non-stretchable portion 81 and the second non-stretchable potion 82. The second stretchable section 84 is in a corrugated shape related to the first stretchable section 83, and connected to the first non-stretchable portion 81 and the second non-stretchable potion 82 on the other side.

The stretchable packaging element 8 further comprises a middle stretchable section 85 which is in a corrugated shape and mounted between the first stretchable section 83 and the second stretchable section 84. The middle stretchable section 85 having two ends connected to the first non-stretchable portion 81 and the second non-stretchable portion 82, respectively. The first non-stretchable portion 81 and the second non-stretchable portion 82 comprise projections 811, 821 for supporting and cushioning the article, respectively. The first non-stretchable portion 81 and the second non-stretchable portion 82 form a corrugated surface 812, 822 for contacting the article and for cushioning the article, respectively.

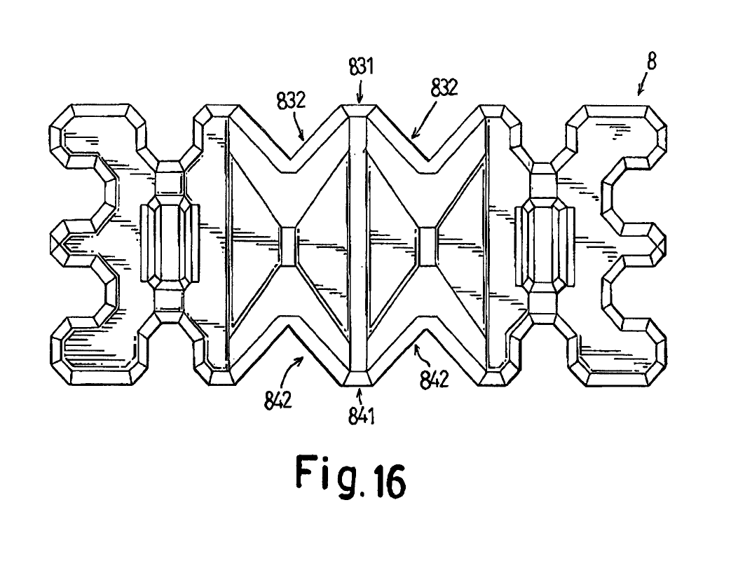

The first stretchable section 83 further comprises at least one non-stretchable strip 831 and at least one stretchable strip 832. The non-stretchable strip 831 and the stretchable strip 832 are alternately connected to form a shape of bellows so that the first stretchable section 83 can be stretched. The second stretchable section 84 has the same structure as the first stretchable portion 83. Referring to FIG. 16, the stretchable strips 832, 842 are stretched to increase the length of the stretchable packaging element 8 so that the stretchable packaging element 8 can package up larger articles,

While an embodiment of the present invention is illustrated and described, various modifications and improvements can be made by persons skilled in the art. The embodiment of the present invention is therefore described in an illustrative but not restrictive sense. It is intended that the present invention may not be limited to the particular forms as illustrated, and that all modifications which maintain the spirit and scope of the present invention are within the scope as defined in the appended claims.

What is claimed is:

1. An extensible packaging element for positioning and cushioning an article, comprising:
two fasteners, mounted on two ends of the packaging element respectively, for linking with another extensible packaging element;
a stretchable portion, mounted between the two fasteners, for connecting the two fasteners.

2. The extensible packaging element as claimed in claim 1, wherein the stretchable portion comprises at least one protrude and at least one slope section, the protrude and the slope section are alternately connected to each other to form the stretchable portion in a shape of bellows.

3. The extensible packaging element as claimed in claim 2, wherein the protrude is not stretchable and the slope section is stretchable.

4. The extensible packaging element as claimed in claim 2, wherein the two fasteners are plates extending downwardly from the protrude.

5. The extensible packaging element as claimed in claim 2, wherein the two fasteners are plates extending upwardly from the slope section.

6. The extensible packaging element as claimed in claim 2, wherein one of the two fasteners is a plate extending downwardly from the protrude, the other fastener is a plate extending upwardly from the slope section.

7. The extensible packaging element as claimed in claim 2, wherein the protrude comprises at least one low protrude which is lower than the protrude.

8. An extensible comer packaging element for positioning and cushioning a corner of an article, comprising:
a support portion having edges, for supporting the corner of the article;
at least two fasteners connected to the edges of the support portion, for linking with the extensible packaging element as claimed in claim 1.

9. The extensible corner packaging element as claimed in claim 8, wherein the comer packaging element comprises three fasteners.

10. The extensible comer packaging element as claimed in claim 8, wherein the fasteners are plates extending downwardly from the edges of the support portion.

11. The extensible corner packaging element as claimed in claim 8, wherein the fasteners are plates extending upwardly from the edges of the support portion.

12. A stretchable packaging element for positioning and cushioning an article, comprising:
two non-stretchable portions, having a first non-stretchable portion and a second non-stretchable portion respectively mounted on two sides of the packaging element;
a stretchable portion, mounted between the two non-stretchable portions, connected to the first non-stretchable portion and the second non-stretchable portion.

13. The stretchable packaging element as claimed in claim 12, wherein the first non-stretchable portion and the second non-stretchable portion comprise a projection for supporting and cushioning the article.

14. The stretchable packaging element as claimed in claim 12, wherein the first non-stretchable portion and the second non-stretchable portion respectively form a corrugated surface for contacting the article and for cushioning the article.

15. The stretchable packaging element as claimed in claim 12, wherein the stretchable portion comprises at least one non-stretchable strip and at least one stretchable strip, the non-stretchable strip and the stretchable strip are alternately connected to form the flexible portion in a shape of bellows.

16. The stretchable packaging element as claimed in claim 12, wherein the stretchable portion comprises:
a first stretchable section, in a corrugated shape connected to the first non-stretchable portion and the second non-stretchable potion;
a second stretchable section, having a corrugated shape related to the first stretchable section, and connected to the first non-stretchable portion and the second non-stretchable potion on the other side.

17. The stretchable packaging element as claimed in claim 16, further comprising a middle stretchable section formed a corrugated shape and mounted between the first stretchable section and the second stretchable section, the middle stretchable section having two ends respectively connected to the first non-stretchable portion and the second non-stretchable portion.

18. The stretchable packaging element as claimed in claim 16, wherein the first non-stretchable portion and the second non-stretchable portion further comprise a projection for supporting and cushioning the article.

19. The stretchable packaging element as claimed in claim 16, wherein the first non-stretchable portion and the second non-stretchable portion respectively form a corrugated surface for contacting the article and for cushioning the article.

20. The stretchable -packaging element as claimed in claim 16, wherein the first stretchable section and the second stretchable section further comprise at least one non-stretchable strip and at least one stretchable strip, the non-stretchable strip and the stretchable strip are alternately connected.
